(19) United States
(12) Patent Application Publication
(10) Pub. No.: US 2003/0040599 A1
(43) Pub. Date: Feb. 27, 2003

(54) Reduction of extractable protein in natural rubber latex articles

(76) Inventors: Apala Mukherjee, South Orange, NJ (US); Stanislaw Petrash, Whippany, NJ (US); Chaodong Xiao, East Hanover, NJ (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/209,487

(22) Filed: Jul. 30, 2002

Related U.S. Application Data
(60) Provisional application No. 60/312,032, filed on Aug. 13, 2001.

(51) Int. Cl. C08G 2/00

(52) U.S. Cl. 528/480

(57) ABSTRACT

The present invention is directed to a process for reducing the extractable protein content of a natural rubber latex article comprising the steps of immersing a former in a coagulant solution to coat the former, immersing said coagulant-coated former into a natural rubber latex to coat the former with said latex, allowing the latex on the former to dry to form a gel-like deposit, leaching the cured latex on the former in at least one aqueous solution, and removing the finished glove from the former. The process is especially useful when the leaching is done in a buffered solution, or a series of alternating buffer/water solutions. The process is also useful in reducing the level of extractable protein in a polymer coated natural latex glove. The process can reduce the level of extractable protein below 300 micrograms/gram and lower.

This application claims priority pursuant to 35 U.S.C. §119 from U.S. Provisional Application Ser. No 60/312,032 filed Aug. 13, 2001.

### FIELD OF THE INVENTION

This invention relates to a process for reducing extractable protein from a natural latex article, especially latex gloves, and in particular from polymer coated latex gloves.

### BACKGROUND OF THE INVENTION

Natural latex is used in the production of formed latex articles, and in particular, latex gloves, since it has superior processing behavior and produces articles having high physical strength.

One problem with natural rubber latex articles is that the latex contains allergenic proteins, and cases of contact urticaria, anaphylactic shock and related responses have been reported on exposure to latex articles. While the incidence of allergic reactions is low, the severity of said reactions can be quite severe. Consequently, there have been many efforts to reduce the levels of extractable proteins.

Several methods for reducing the extractable protein levels have been reported.

Novo Nordisk A/S in Research Disclosure, Mar. 10, 1992, No. 335102 discloses that treatment of latex or latex goods with a protease is effective for changing allergenic proteins to non-antigens. Novo Nordisk also discloses in U.S. Pat. No. 6,107,455 a method for lowering the extractable protein content in natural rubber latex by washing a rubber article, such as rubber glove, with an aqueous solution containing a soluble silicate and, optionally, a protease. AU-A-44456/93 (Sumitomo Rubber Ind. & Kao Corp.) discloses a treatment of natural rubber latex with a protease, an anionic surfactant and/or a non-ionic surfactant. AU-A-63069/94 and AU-A-63070/94 (both to Sumitomo Rubber Ind. & Kao Corp.) disclose a treatment of a natural rubber latex with a protease and a surfactant, followed by the addition of an anionic, amphoteric or non-ionic surfactant, oligomer or polymer, to improve the mechanical stability. However, those methods have not been widely used in the glove manufacturing industry due to high costs associated with the above processes. Currently, the most common means of reducing the extractable protein content of the latex articles are the use of water leaching, and chlorination.

The main purpose of the chlorination process is to reduce the tackiness of the natural rubber article to facilitate the donning of such glove by the user. While being effective in reducing the level of extractable proteins, chlorination causes oxidation of the rubber surface, resulting in degradation of mechanical properties of the rubber. As a result, the protective properties and glove's shelf-life are dramatically reduced.

Water leaching is the process of removing water-soluble materials from a latex article by exposing the article to water. Typically, the leaching is done in-line, prior to drying and vulcanization (cure), while the latex article is still on a former in the wet gel state. This is done to remove the residual coagulant and other water-soluble latex additives. This pre-cure leaching step has also been used to reduce the amount of extractable proteins in rubber glove. It has been found that after the glove is manufactured, up to 95% of the proteins are localized on the inner (donning) surface of the glove—which is on the outside when the glove is on the former. “Latex Allergy Studies: Location of soluble Proteins in Latex Examination Gloves”, Bahri et. al., Journal of Natural Rubber Research, Vol. 8(4), 1993, pages 299-307. We have found that most of these proteins become soluble and localized on the surface of the glove only after the clove has been cured.

Since extractable proteins are water-soluble, they tend to stay within the glove when it is in the wet gel form. Following the dry/cure process, the glove becomes more hydrophobic, as the water evaporates from the air-latex interface. As a result, water soluble proteins migrate to the outside surface. A combination of a wet gel water leaching in combination with a dry-film leaching is disclosed in “Production of Natural Rubber Latex Gloves with Low Extractable Protein Content: Some Practical Recommendations”, Ng et. al., Journal of Natural Rubber Research, Vol. 9(2), 1993, pages 87-95. The dry-film leach occurs as an off-line process, after the glove has been stripped from the former and inverted. The disadvantages of the disclosed off-line dry-film leach, which occurs after the gloves are stripped, is that it requires an additional discontinuous manufacturing step. Such process is also inefficient, since during stripping the glove is inverted and the inside surface, which contains the majority of the extractable proteins, is relatively inaccessible to leaching water.

There is a need for more effective removal of proteins from formed latex articles. As explained above, the online leaching process is expected to be more effective, since the inside surface of the finished glove is the outside surface of the latex deposit, while on the former, and therefore exposed and accessible to treatment. This is especially important for the production of polymer-coated powder-free gloves, where the deposition of the polymer coating is likely to be done after the curing step, which releases additional extractable proteins from the latex. It would be economically advantageous to have one continuous process, which combines pre-cure and post-cure leaching steps on-line, yet still preserves a polymer coating.

Surprisingly, it has been found that a process involving an in-line leaching after curing, especially when combined with an in-line leaching before cure, provides a marked reduction in the extractable protein level of a polymer coated latex article, which cannot be achieved by pre-cure leaching alone. This process are also does not negatively affect the polymer coating in polymer-coated rubber latex gloves. Leaching with a buffered solution also leads to a reduction in extractable protein.

### SUMMARY OF THE INVENTION

The present invention is directed to a process for reducing the extractable protein content of a natural rubber latex article comprising the steps of

a) immersing a former in a coagulant solution to coat the former with a layer of coagulant;

b) immersing said coagulant-coated former into a natural rubber latex to deposit a latex layer onto the former;

c) allowing the latex on the former to partially dry to form a gel-like deposit;

d) curing the latex on said leached latex-coated former;

e) leaching the cured latex on the former in at least one aqueous solution; and

f) removing the finished article from the former.

Optionally the latex-coated former may also be leached in an aqueous solution prior to curing [between steps c) and d)].

The invention is also directed to a process for reducing the extractable protein of a polymer coated natural latex formed article.

The invention is further directed to a polymer-coated natural rubber latex article having an extractable protein level of below 300 micrograms/gram, produced by the process of the invention.

### DETAILED DESCRIPTION OF THE INVENTION

The present invention relates to a process for reducing the level of extractable proteins in a formed natural latex rubber article. The process involves a post-cure leaching of the article while still on-line, with the surface, which will become the inner surface after stripping and inversion, still on the outside and exposed to the leaching solution. While not being bound by any particular theory, it is believed the post-cure leach is particularly effective because this is a point in the process in which the extractable proteins have migrated near the outside surface of the glove.

By extractable protein, as used herein, is meant proteins that are found in natural rubber latex that are capable of being extracted from a coagulated rubber article, either prior to- or after-curing. The proteins are either water soluble, or have a hydrophilic nature allowing them to be removed by water.

By leaching, as used herein, is meant the extraction of proteins from the formed natural rubber latex by contacting the formed latex article with water or an aqueous solution. Leaching most often occurs by the immersion of the latex article into an aqueous solution. Leaching can also occur by other means in which the latex article is contacted water or an aqueous solution, such as rinsing, spraying or brushing.

The amount of extractable protein in a finished natural latex formed article is related to the ability to either remove extractable proteins during the manufacturing process, or to bind the proteins in some manner so that they cannot be extracted.

Curing of the latex rubber formed article changes the nature of the article from a hydrophilic gel to a hydrophobic article. This is accomplished by removing the water from the latex deposit during curing process. The water, accompanied by the hydrophilic extractable proteins, migrate toward the outer surface of the article during such curing. Said extractable proteins, accumulated on the outer surface of the cured article, could be then very effectively leached online immediately after the curing step. When glove is the optionally coated with polymer, and inverted during stripping, the outer surface which was depleted during the post-cure leaching becomes inner, wearer-contacting surface.

The key factor in the invention is a post-cure leaching in an aqueous solution of the formed natural rubber article while the surface which will become the inner surface of the article following stripping and inversion is exposed to the leaching solution. This method can be used alone or along with a pre-leaching step to further reduce the amount of protein in the formed latex articles.

The leaching step may be a single immersion of the cured rubber article in an aqueous solution, or preferably consists of multiple immersions in different aqueous solutions. The number of immersion steps, and the total length of leaching time is a function of the limitations of any particular manufacturing process. The total amount of leaching time encompassed by the present invention can range from 30 seconds to several hours. From a practical standpoint, it is preferred if the total leaching time is from 30 seconds to 30 minutes, more preferably from 1 minute to 20 minutes, and most preferably from 1 minute to 15 minutes.

The leaching process may consist of a single immersion, or several different immersions in different aqueous solutions. From a practical standpoint, it is preferred that the number of different immersions (solutions) is from 1 to 20, preferably from 2 to 8, more preferably from 3 to 6 and most preferably 4 or 5.

The leaching solution may be water only, a buffered solution, a salt solution, or a buffered salt solution. Alternating between different solutions provides positive results, such as alternating from water to buffer to water, from salt to buffer to water, or from cold buffer to hot water. The order of the leaching sequence can be an important factor. In one preferred embodiment, the leaching consists of water, buffer, water, buffer, and finally water.

The buffer solution, whether with or without salt, has a pH of from 2 to 14,preferably from 3 to 13, and most preferably 3 to 12. The buffer can be any buffer system known in the art, such as, for example a phosphate buffer. The greater the pH deviation from the isoelectric point of the latex proteins, the more effective the leaching of said proteins.

A salt solution, buffered or unbuffered, has a concentration of ions of from 0.01 percent to 10 percent by weight, preferably from 0.5 percent to 7percent, most preferably from 0.7percent to 5 percent by weight based on the weight of the solution. The salt may consist of any mono-, di-, or multi-valent salt known in the art, such as sodium chloride, potassium chloride, sodium iodide, potassium sulfate, ammonium sulfate, and other common water-soluble salts known in the art. A preferred salt is sodium chloride. If multiple solutions are used, they can be of the same or different ionic concentration.

The temperature of the leaching bath effects the solubility of the protein, and thus the amount of protein extracted. For practical reasons in the manufacturing process, the leaching bath temperature is between 20° C. and 100° C., preferably from 30° C. to 90° C., most preferably 40° C. to 80° C. In one preferred embodiment, gloves are leached in cold buffer, followed by hot water. This was more effective in the leaching of proteins than hot buffer/hot water, or cold buffer/cold water.

The addition of water-miscible solvents, such as acetone, dimethyl sulfoxide, dimethylformamide and alcohols, can be used in the leaching sequence to remove proteins.

Surfactants, such as sodium dodecyl sulfate, can be used as a replacement for some or all of the salt-buffer. Ethylene diamine tetraacetic acid (ETDA) and other known metal chelating agents can aid in the extraction of proteins.

Agents which act on the proteins to change the solubility are also useful in the present invention. Such agents include enzymes which recognize particular sequences of amino acids and cleave the peptide bonds; and acids which cleave disulfide bonds, thereby helping to unfold and solubilize proteins. Also included would be agents that cause the protein to cross-link, leading to a smaller molecule which could be more easily extracted; or agents causing the protein to cross-link and bind to the matrix, making extraction difficult.

Any treatment which results in crosslinking of the latex rubber surface can also result in a reduction in extractable protein, the cross-linked surface is harder for the proteins to penetrate, thereby making extraction more difficult.

Other factors known in the art to affect solubility can be adjusted by one of skill in the art to optimize the reduction of extractable protein remaining in the finished natural rubber article. These factors include, but are not limit to, agitation of the leaching bath, the type of latex (amount of extractable protein in the latex), and sonication.

The level of extractable protein remaining in the finished formed natural rubber article should be less than 300 micrograms per gram, preferably less than 200 micrograms per gram, more preferably less than 100 micrograms per gram, and most preferably less than 50 micrograms per gram.

The post-cure leaching can be used as the sole in-line leaching process, or can be used in combination with a pre-cure leaching procedure. As with the post-cure leaching, pre-cure leaching can involve single or multiple solutions; water, salt, and/or buffered solutions; different immersion times; different temperatures; and a variety of other factors which can be optimized for a given process.

The post-cure leaching can also be used in conjunction with chlorination. The chlorination can be by any means known in the art.

The post-cure leaching of the present invention can be used for polymer coated formed articles, such as gloves, catheters, condoms, and other latex articles. To be effective, the leaching procedure must remove extratable protein without removing or damaging the polymer coating. The polymer coating can be on the inside glove surface, the outside surface, or on both surfaces of the article. Surprisingly, it has been found that the polymer coating survives the leaching process, to produce a useful polymer-coated, powder-free glove, with a reduced level of extractable protein.

An additional benefit of the post-cure leach is an improvement in mold release.

The following examples are presented to further illustrate and explain the present invention and should not be taken as limiting in any regard.

Testing for extractable protein is performed in accordance with ASTM D 5712-99 (modified colorimetric Lowry assay) and the protein content is reported in micrograms/ gram of finished glove article.

### EXAMPLE 1

A former is dipped into a coagulant, dried and dipped into latex. After pre-curing the latex, the former is dipped into water at 70° C. and leached for 2 minute. After that the former is dipped into the slurry tank and coated with polymer. After curing in the oven, the former is taken out and leached into water (70° C.) for 2 minutes. After that, the finished article is stripped from the former.

### EXAMPLE 2 (COMPARATIVE)

A former is dipped into a coagulant, dried and dipped into latex. After pre-curing the latex, the former is dipped into the slurry tank and coated with polymer. After curing in the oven, the finished article is stripped from the former.

### EXAMPLE 3

A former is dipped into a coagulant, dried and dipped into latex. After pre-curing the latex, the former is dipped into the slurry tank and coated with polymer. After curing in the oven, the former is taken out and leached into water (70° C.) for 2 minutes. After that, the finished article is stripped from the former.

### EXAMPLE 4 (COMPARATIVE)

A former is dipped into a coagulant, dried and dipped into latex. After pre-curing the latex, the former is dipped into water at 70° C. and leached for 2 minutes. After that the former is dipped into the slurry tank and coated with polymer. After curing in the oven the finished article is stripped from the former.

TABLE 1
Extractable protein measured in accordance with ASTM D 5712-99

| Samples | micrograms/g |
|---|---|
| Example 1 | 43 |
| Example 2 (comparative) | 1478 |
| Example 4 (comparative) | 711 |

### EXAMPLE 5

A former is dipped into a coagulant, dried and dipped into latex. After pre-curing the latex, the former is dipped into the slurry tank and coated with polymer. After curing in the oven, the former is taken out and leached into phosphate buffer saline (PBS, pH 7.4, 25° C.), for 30 seconds, water (70° C.) for 30 seconds, PBS (pH 7.4, 25° C.), for 30 seconds, followed by water for 90 seconds (70° C.). After that, the finished article is stripped from the former.

### EXAMPLE 6

A former is dipped into a coagulant, dried and dipped into latex. After pre-curing the latex, the former is dipped into the slurry tank and coated with polymer. After curing in the oven, the former is taken out and leached into water (70° C.) for 30 seconds, phosphate buffer saline (PBS, pH 7.4, 25° C.), for 30 seconds, water (70° C.) for 30 seconds, PBS (pH 7.4, 25° C.), for 30 seconds, followed by water for 1 minute. After that, the finished article is stripped from the former.

### EXAMPLE 7

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 30 seconds, phosphate buffer saline (PBS, 25° C., pH 7.4), for 30 seconds, water (70° C.) for 30 seconds, PBS (25° C., pH 7.4), for 30 seconds, followed by water for 1 minute. After that, the finished article is stripped from the former.

### EXAMPLE 8

A former is dipped into a coagulant, dried and dipped into latex. After pre-curing the latex, the former is leached into water (70° C.) for 30 seconds, phosphate buffer saline (PBS, 25° C., pH 7.4), for 30 seconds, water (70° C.) for 30 seconds, PBS (25° C., pH 7.4), for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 9 (COMPARATIVE)

A former is dipped into a coagulant, dried and dipped into latex. After pre-curing the latex, the former is leached in phosphate buffer saline (PBS, 25° C., pH 7.4) for 30 seconds, water (70° C.) for 30 seconds, PBS (25° C., pH 7.4) for 30 seconds, water (70° C.) for 30 seconds, PBS (25° C., pH 7.4) for 30 seconds, water (70° C.) for 30 seconds, and finally in water for 1 minute. After that the former is dipped into the slurry tank and coated with polymer. After curing in the oven the finished article is stripped from the former.

### EXAMPLE 10

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 30 seconds, phosphate buffer (25° C., pH 12), for 30 seconds, water (70° C.) for 30 seconds, phosphate buffer (25° C., pH 12) for 30 seconds, followed by water for 1 minute. After that, the finished article is stripped from the former.

### EXAMPLE 11

A former is dipped into a coagulant, dried and dipped into latex. After pre-curing the latex, the former is leached into water (70° C.) for 30 seconds, phosphate buffer (25° C., pH 12) for 30 seconds, water (70° C.) for 30 seconds, phosphate buffer (25° C., pH 12) for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 12

A former is dipped into a coagulant, dried and dipped into latex. After pre-curing the latex, the former is leached into water (70° C.) for 30 seconds, sodium dodecyl sulfate, SDS, (25° C.) for 30 seconds, water (70° C.) for 30 seconds, SDS (25° C.) for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 13

A former is dipped into a coagulant, dried and dipped into latex. After pre-curing the latex, the former is leached into water (70° C.) for 30 seconds, saline solution (25° C.) for 30 seconds, water (70° C.) for 30 seconds, saline solution (25° C.) for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 14

A former is dipped into a coagulant, dried and dipped into latex. After pre-curing the latex, the former is leached into water (70° C.) for 30 seconds, PBS (25° C., pH 7.4) for 30 seconds, phosphate buffer (25° C., pH 8.5) for 30 seconds, saline solution (25° C.) for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 15

A former is dipped into a coagulant, dried and dipped into latex. After pre-curing the latex, the former is leached into sonicated in PBS (pH 12, 25° C.) for 30 seconds, water (70° C.) for 30 seconds, sonicated in PBS (25° C.) for 30 seconds, followed by water for 1 minute. After that the former is dipped into the slurry tank and coated with polymer. After curing in the oven, the former is taken out and leached in water (70° C.) for 2 minutes. The finished article is stripped from the former.

### EXAMPLE 16 (COMPARATIVE)

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the finished article is stripped from the former.

### EXAMPLE 17

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 2 minutes. After that, the finished article is stripped from the former.

### EXAMPLE 18

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 3 minutes. After that, the finished article is stripped from the former.

### EXAMPLE 19

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 5 minutes. After that, the finished article is stripped from the former.

### EXAMPLE 20

A former is dipped into a coagulant, dried and dipped into latex. After pre-curing the latex, the former is dipped into water at 70° C. and leached for 1 minute. After that the former is dipped into the slurry tank and coated with polymer. After curing in the oven, the former is taken out and leached into water (70° C.) for 7 minutes. After that, the finished article is stripped from the former.

TABLE 2
Extractable protein measured in accordance with ASTM D 5712-99

| Samples | micrograms/g |
|---|---|
| Example 16 | 444 |
| Example 17 | 204 |
| Example 18 | 210 |
| Example 19 | 156 |
| Example 20 | 68 |

### EXAMPLE 21

A former is dipped into a coagulant, dried and dipped into latex. After pre-curing the latex, the former is dipped into water at 70° C. and leached for 1 minute. After curing in the oven up to former temperature of 55° C., the former is taken out and leached into water at 70° C. for 2 minutes. After that the former is dipped into the slurry tank and coated with polymer. After that, the finished article is stripped from the former.

### EXAMPLE 22

A former is dipped into a coagulant, dried and dipped into latex. After pre-curing the latex, the former is dipped into water at 70° C. and leached for 1 minute. After curing in the oven up to former temperature of 60° C., the former is taken out and leached into water at 70° C. for 2 minutes. After that the former is dipped into the slurry tank and coated with polymer. After that, the finished article is stripped from the former.

### EXAMPLE 23

A former is dipped into a coagulant, dried and dipped into latex. After pre-curing the latex, the former is dipped into water at 70° C. and leached for 1 minute. After curing in the oven up to former temperature of 64° C., the former is taken out and leached into water at 70° C. for 2 minutes. After that the former is dipped into the slurry tank and coated with polymer. After that, the finished article is stripped from the former.

### EXAMPLE 24

A former is dipped into a coagulant, dried and dipped into latex. After pre-curing the latex, the former is dipped into water at 70° C. and leached for 1 minute. After curing in the oven up to former temperature of 70° C., the former is taken out and leached into water at 70° C. for 2 minutes. After that the former is dipped into the slurry tank and coated with polymer. After that, the finished article is stripped from the former.

### EXAMPLE 25

A former is dipped into a coagulant, dried and dipped into latex. After pre-curing the latex, the former is dipped into water at 70° C. and leached for 1 minute. After curing in the oven up to former temperature of 75° C., the former is taken out and leached into water at 70° C. for 2 minutes. After that the former is dipped into the slurry tank and coated with polymer. After that, the finished article is stripped from the former.

### EXAMPLE 26

A former is dipped into a coagulant, dried and dipped into latex. After pre-curing the latex, the former is dipped into water at 70° C. and leached for 1 minute. After curing in the oven up to former temperature of 80° C., the former is taken out and leached into water at 70° C. for 2 minutes. After that the former is dipped into the slurry tank and coated with polymer. After that, the finished article is stripped from the former.

### EXAMPLE 27

A former is dipped into a coagulant, dried and dipped into latex. After pre-curing the latex, the former is dipped into water at 70° C. and leached for 1 minute. After curing in the oven up to former temperature of 85° C., the former is taken out and leached into water at 70° C. for 2 minutes. After that the former is dipped into the slurry tank and coated with polymer. After that, the finished article is stripped from the former.

### EXAMPLE 28

A former is dipped into a coagulant, dried and dipped into latex. After pre-curing the latex, the former is dipped into water at 70° C. and leached for 1 minute. After curing in the oven up to former temperature of 94° C., the former is taken out and leached into water at 70° C. for 2 minutes. After that the former is dipped into the slurry tank and coated with polymer. After that, the finished article is stripped from the former.

### EXAMPLE 29

A former is dipped into a coagulant, dried and dipped into latex. After pre-curing the latex, the former is dipped into water at 70° C. and leached for 1 minute. After curing in the oven up to former temperature of 106° C., the former is taken out and leached into water at 70° C. for 2 minutes. After that the former is dipped into the slurry tank and coated with polymer. After that, the finished article is stripped from the former.

TABLE 3
Extractable protein measured in accordance with ASTM D 5712-99

| Samples | micrograms/g |
|---|---|
| Example 21 | 59 |
| Example 22 | 46 |
| Example 23 | 40 |
| Example 24 | 42 |
| Example 25 | 42 |
| Example 26 | 44 |
| Example 27 | 44 |
| Example 28 | 45 |
| Example 29 | 56 |

### EXAMPLE 30

A former is dipped into a coagulant, containing calcium carbonate mold release agent, dried and dipped into latex. After pre-curing the latex, the former is dipped into water at 65° C. and leached for 1 minute. After curing in the oven up to former temperature of 106° C., the former is taken out and leached into water at 75° C. for 2 minutes. After that the former is dipped into the calcium carbonate slurry tank. After that, the finished article is stripped from the former.

### EXAMPLE 31

A former is dipped into a coagulant, containing calcium carbonate mold release agent, dried and dipped into latex. After pre-curing the latex, the former is dipped into water at 65° C. and leached for 1 minute. After curing in the oven up to former temperature of 106° C., the former is taken out and leached into water at 75° C. for 2 minutes. After that the former is dipped into the slurry tank and coated with polymer. After that, the finished article is stripped from the former.

### EXAMPLE 32

A former is dipped into a coagulant, containing polymeric mold release agent, dried and dipped into latex. After pre-curing the latex, the former is dipped into water at 65° C. and leached for 1 minute. After curing in the oven up to former temperature of 106° C., the former is taken out and leached into water at 75° C. for 2 minutes. After that the former is dipped into the calcium carbonate slurry tank. After that, the finished article is stripped from the former.

### EXAMPLE 33

A former is dipped into a coagulant, containing polymeric mold release agent, dried and dipped into latex. After pre-curing the latex, the former is dipped into water at 65° C. and leached for 1 minute. After curing in the oven up to former temperature of 1 06° C., the former is taken out and leached into water at 75° C. for 2 minutes. After that the former is dipped into the slurry tank and coated with polymer. After that, the finished article is stripped from the former.

TABLE 4
Extractable protein measured in accordance with ASTM D 5712-99

| Samples | micrograms/g |
|---|---|
| Example 30 | 85 |
| Example 31 | 63 |
| Example 32 | 45 |
| Example 33 | 43 |

1. A process for reducing the extractable protein content of a natural rubber latex article comprising the steps of
a) immersing a former in a coagulant solution to coat the former with a layer of coagulant;
b) immersing said coagulant-coated former into a natural rubber latex to deposit a latex layer onto the former;
c) allowing the latex on the former to partially dry to form a gel-like deposit;
d) curing the latex on said leached latex-coated former;
e) leaching the cured latex on the former in at least one aqueous solution; and
f) removing the finished article from the former.

2. The process of claim 1 wherein said aqueous solution contains from 0.01 to 10 percent by weight of ionic content.

3. The process of claim 2 wherein said ionic content is from 0.5 to 7 percent by weight.

4. The process of claim 1 wherein said leaching occurs for from 30 seconds to 30 minutes.

5. The process of claim 4 wherein said leaching occurs for from 1 to 20 minutes.

6. The process of claim 1 wherein said leach step e) consists of from 1 to 8 separate immersion steps in different tanks, said aqueous solutions in each tank may be the same or different solutions.

7. The process of claim 1 wherein said aqueous solution comprises a buffered solution having a pH of from 2 to 14.

8. The process of claim 7 wherein said buffered solution pH is between 3 and 12.

9. The process of claim 1 wherein said aqueous solution has a temperature of from 30° C. to 90° C.

10. The process of claim 1 further comprising leaching the latex article in an aqueous solution prior to curing between steps c) and d).

11. The process of claim 1 wherein said article is coated directly on at least one side with a polymer coating.
